(19) United States
(12) Patent Application Publication
(10) Pub. No.: US 2003/0175400 A1
(43) Pub. Date: Sep. 18, 2003

(54) Pressed compositions capable of rapid dissolution in liquid

(75) Inventors: Harald Schlosser, Ellwangen (DE); Armin Ungerer, Crailsheim (DE)

Correspondence Address: Mr. Terry B. Morris, Tomeny & Fisher, 6709 Perkins Rd., Baton Rouge,, LA, 70808, US

(73) Assignee: J. Rettenmaier & Sohne GmbH + Co KG, Rosenberg (DE)

(21) Appl. No.: 10/235,378

(22) Filed: Sep. 5, 2002

(30) Foreign Application Priority Data
Mar. 15, 2002 (DE) DE 102 11 427

(51) Int. Cl. C12C 1/00

(52) U.S. Cl. 426/590

(57) ABSTRACT

A composition containing finely-reduced utilizable material which is intended for human and/or animal consumption and a finely-reduced dispersion-promoting additive contain. The composition is pressed from an essentially homogeneous mixture of the finely-reduced utilizable material and the dispersing agent. The dispersing agent is in the form of a finely-reduced cellulose-containing material, which is compacted under mechanical pressure. An optional swelling material is provided as well as granulated forms for the materials. The composition has a characteristic of rapidity in dissolution.

This invention relates to pressed compositions capable of rapid dissolution in liquids. More particularly, the invention relates to the rapid dissolution of the composition in liquid with release of its content materials which are intended for human and/or animal consumption. Such composition comprises one or more finely-reduced utilizable material(s) and one or more finely-reduced decay-promoting additive(s) (alternative termed “dispersing agent” or “dissolving-promoting agents” or the like herein).

Similar compositions are known in the art. One similar composition is disclosed in DE 199 19 204 A1. Exemplary materials in that document useable as the utilizable material include finely-reduced flavor carriers with known forms for the intended use for the preparation of beverages such as coffee, cocoa, cappuccino, tea and the such: The additive is a liquid conductive material of a cellulose basis with at least a decay-promoting separator. This additive can supplement the components of the pressed compositions as a later added supplemental material and can be present as coating of the finely-reduced (utilizable) material of cellulose basis and/or the finely-reduced flavor carrier. The separator is to serve to prevent to a large extent the clinging together of the cellulose particles.

From DE 197 09 991 C2 different pressed compositions are known, which are not intended for human consumption. This document concerns washing detergent compositions, which are pressed from a mixture of the detergent composition with an expanding material, which fine-particle, cellulose-containing material is compacted under mechanical pressure and then completed in granulated form.

The present invention is based on the task to create a pressed composition whose introduction into liquid of utilizable material related directly or indirectly for human and/or animal consumption is rapid and which exhibits acceptable short decay times.

This task is solved by the invention of the present application.

The pressed compositions according to the invention can serve for preparing rapid human consumables, e.g. for the production of the following:

Diet drinks, fiber material drink, pudding, vegetable, spices, instant sauces, instant soups, soup stock cubes, herbs, coffee, tea, cocoa, cappuccino, espresso, milk powder, coffee creamer, salt, baby food, beverages, vitamin, ready-to-eat meals, flavors, taste enhancers, coloring materials, energy food, thickening agents, sauce binders and mixtures from such.

The liquid, in which the pressed compositions is dissolved, is primarily water; but also an other liquid can be used, such as milk, broth, juice and the like.

The liquid, in which the pressed compositions is dispersed, can be hot or cold.

The finished preparation can exhibit an essentially aqueous consistency as in the case of beverages. In addition, firmer consistencies are possible as in the case of puddings, vegetable dishes and the like.

The utilizable material can serve directly as the consumption or only indirectly, by being added to another preparation, as in the case of spices, salt, flavors, coloring materials and the like.

The dispersing agent is present in granulated form. It is compacted from fine particle cellulose-containing material under mechanical pressure and then granulated. In this form the utilizable material and the additive are mixed in proportion with each other and, optionally, a swelling agent to effectively dissolve the composition, preferably in less than two minutes when introduced into liquid. In a more preferable embodiment, the utilizable material and the additive are essentially homogeneously mixed and, if necessary pregranulated, and injected then into the pressed compositions. For this all are possible in considering the art of the technology of known pressing methods, in particular tableting, and in addition, extruding, pelletizing, granulation and the like.

The dispersing agent comprises cellulose-containing material of different provenance. For example, it can comprise cellulose, MCC (micro-crystalline cellulose), wood, CTMP (chemothermal mechanical pulp) or also cereal covers such as oats, wheat and also corn or rice. Furthermore residual sediments of the juice production of oranges, lemons, tomatoes, apples, and grape clusters come into consideration; likewise grape residue and sugar beet residues of the sugar production. Also vegetables such as peas, cabbage, potatoes, cucumber, can serve for the generation of the cellulose-containing material, as well as coconuts and nuts, can serve, as well as coffee extraction residues, which stay with the instant coffee.

The aforementioned cellulose-containing materials work within the manufactured pressed compositions as water-insoluble ballast materials for rapid human and/or animal consumption preparations and have to that extent, except for their pure dispersion function, still a nourish-physiological auxiliary use.

All these materials can be modified chemically and/or physically before their preparation in the dispersing agent, and before they are compacted and granulated.

The expression “compacted” is to mean here the practice of a mechanical pressure on the cellulose-containing material, which squeezes the volume together of the cellulose-containing material, whereby the fibers remain enlarged. It is only the lumen of the fibers which is reduced as the particles supposedly distorted during compacting, in contrast to the aggregation, in which only a mutual accumulation is given to the particle without substantial change of its shape. Compacting in this sense is to be made before the admixture of the so-made dispersing agent to the utilizable contents materials. If then the pressed compositions according to invention comes into contact with water or other liquid, the cellulose-containing material swells up again from its compacted condition into a condition with open, relaxed volume. Whether this procedure is based on capillary or other forces is not certain. Anyhow the volume increase is substantially stronger than that which normally develops with a pure swelling of an uncompacted cellulose-containing material.

The supply of the cellulose-containing material is just as important as the granulates. The sense of this measure exists in that the individual fine particle of the cellulose-containing material in contact with the liquid experiences the same relative volume increase as that of a larger aggregate. However the absolute volume increase of a fine particle is too small. In order to accomplish the objective of the pressed compositions, a local expansion sufficient for the cracking is needed. In the granulated particles the individual amounts add themselves to a macroscopic local expansion with sufficient explosive effect.

The characteristics of the utilizable material and those of the dispersing agent must be adapted depending upon kind and use of the utilizable material.

For the finely-reduced utilizable material an average particle size is preferably within the range of about 1 to about 8000 micrometers (μm), more preferably within the range of about 15 to about 3000 μm.

The dispersing agent can be preferably an average particle size of about 100 to about 6000 μm.

As it concerns only dispersing, the dispersing agent parts by weight in the finished pressed compositions of up to about 15 weight percentage are sufficient. In accordance with one embodiment of the present invention the dispersing agent can be present in a part by weight from about 2 to about 80%. The higher parts by weight are possible, in particular, if the dispersing agent possesses still another auxiliary function. For example, the dispersing agent can work as the fiber in fiber material drinks.

In another embodiment of the present invention, the pressed composition according to invention is distributed essentially homogeneously in the mass of the pressed composition. According to this particular embodiment, the pressed composition additionally comprises a swelling means. As “swelling means” is to be understood is a means which readily swells without compacting by liquid up-take alone and, in this way, is able to loosen the cohesion of the pressed compositions by contact with the liquid into which it is entered.

Examples of swelling means are: Polysaccharide, interlaced (cross-linked) polysaccharide, chemically modified polysaccharide, chemically modified interlaced polysaccharide and their combinations. For example, it can include interlaced CMC (carboxymethyl cellulose), e.g. the product “VIVASOL” of the company J. Rettenmaier & Soehne GmbH+Company Limited Partnership, interlaced CMS (carboxymethyl starch),e.g. the product “VIVASTAR” of the company J. Rettenmaier & Soehne GmbH +Company Limited Partnership, starches, modified starches, guar, xanthan, and bread flour meal (e.g. German Johannesbrotkernmehl as an example).

In accordance with yet another embodiment of the present invention, the swelling means can be an additional means existing apart from the dispersing agent in the pressed compositions. The possibility that the dispersing agent is a swelling means is not impossible however and is an embodiment of the present invention.

There are also certain cases in which the swelling means is not necessary and in which the pressed compositions in the liquid disintegrates sufficiently fast and thoroughly only due to the effect of the dispersing agent.

In a preferred embodiment, the dispersing agent grain fibers contains oats fibers or wheat fibers. The grain fibers have a sufficient dispersability in order to be able to dissolve such as for a cocoa tablet in milk.

The grain fibers are particularly effective if they are treated according to the CTMP procedure disclosed in “Chemo Results In Thermal Mechanical Pulp” and incorporated herein in its entirety.

Pure cellulose or pure pulp does not function when employed as dispersing agents without additional swelling means.

The continuing idea with the swelling means consists of uniting by the combination of a dispersing agent of the aforementioned kind with a swelling means of a high swelling volume with high swelling strength. The particles of the swelling means have also the function to hold the particles of the cellulose-containing dispersing agent to certain extent distance, that is, to work as a kind of spacer, and so to reduce the development of hydrogen bonds between the particles of the dispersing agent, which could work against a decay of the pressed compositions.

The finely-reduced swelling means is compacted in accordance with one embodiment of the present invention under mechanical pressure and is present in the pressed compositions as granulates.

One procedure alternative for the production of such pressed compositions comprises the compaction of the finely-reduced swelling means and subsequential granulation. Then the composition is mixed essentially homogeneous and injected then with the fine-cutup utilizable material and the compacted and granulated dispersing agent.

Another procedure for the production of the compressed compositions comprises mixing the finely-reduced swelling means essentially homogeneously with the finely-reduced dispersing agent and compacted and granulated then and this granulate is then mixed with the finely-reduced utilizable material and pressed.

Below the results of some tablet sample experiments are reported using the dispersing agent according to invention. The tablets were manufactured in a cylindrical form 35 millimeter in diameter, which is closed at an end, into which the mixture of the fine particle material which can be pressed is filled and into the open side a piston is pushed in, which squeezes the material together. The pressing force is determined by suitably attached strain gauges. Squeezing the pressed compositions together took place in a suitable press.

In the following experimental examples the percentage sign always mean weight percentage.

1. Tablet experiment with cocoa powder

Test conditions:

Tablet diameter: 35 millimeter

Tablet weight: 21 and/or 22 grams=20 grams of utilizable material (cocoa beverage powder as commercial product of Satro or Nestlé) and the weight of the dispersing agent in the form of the product HF 0414, which is granulated from oats fibers in a roller stool compaction and on a particle size from approximately 0.4 to 1.4 millimeter and exhibits a bulk weight from 300 to 500 grams per liter:

Decay determined in 400 millimeters of tap water at 50 degrees Centigrade (° C.).

TABLE 1

| Utilizable material/ | | | |
|---|---|---|---|
| dispersing agent | Pressing force | Stability | Decay time |
| 20 grams (g) cocoa | 20 | i.O*. | no decay after 300 |
| | kiloNewtons | | seconds |
| 20 grams cocoa + 1 | 20 | i.O. | At approximately 300 |
| gram HF 0414 (4.7 | kiloNewtons | | seconds 2 grams residue |
| %) | | | remains |
| 20 grams cocoa + 2 | 20 | i.O. | 70 seconds |
| grams HF 0414 | kiloNewtons | | |
| (9.1%) | | | |
| 20 grams cocoa + 2 | 20 | i.O. | 51 seconds with decay |
| grams HF 0414 | kiloNewtons | | lattice |
| (9.1%) | | | |
| 20 grams cocoa + 2 | 20 | i.O. | 48 seconds with decay |
| grams HF 0414 | kiloNewtons | | lattice |
| (9.1%) | | | |

*in order, e.g. “OK”

Within 50 to 70 seconds the cocoa tablet with approximately 9% dispersing agent HF 0414 disintegrates into its components. The clumps, which stay, separate in practice by agitating.

A test was performed in order to be able to compare the dissolving time of the powder and the tablet. An amount of 20 grams of powders are provided in 200 milliliters tap water (50° C.) and agitated so long until it dissolved. Duration: 45 seconds.

A tablet, consisting of 20 grams cocoapowders and 2 grams HF 0414, is likewise provided in 200 milliliter tap water (50° C.). It is agitated likewise, until it dissolved. Duration: 60 seconds.

With the preceding experiments a dispersing agent was only added to the cocoa powder. For comparison some attempts were performed, in which another swelling means in addition to the dispersing agent was added to the cocoa powder

Test conditions:

Tablet diameter: 35 millimeter

Tablet: 85% utilizable material (cocoa beverage powder as commercial product of Satro or Nestlé)+15% additives, consisting of 90% oats fiber HF 600 (average fiber length 80 μm, average fiber thickness 25 μm) and 10% Vivasol (Crosscarmelose sodium as bursting means (dispersant) for pharmaceutical tablets) as swelling means, mixed, compacted and granulated on a particle size between 0.4 and 1.4 millimeter. The resulting product carries the designation HF 0414 V.

Decay determined in 400 milliliters tap water at 50° Centigrade

TABLE 2

| Utilizable | Dispersing | Swelling | Pressing | | |
|---|---|---|---|---|---|
| material | agent | means | force | Stability | Decay |
| Cocoa | Oats fiber | Vivasol | 20 | i.O. | 37 seconds |
| | | | kiloNewtons | | |

2. Tablet experiment diet drink:

Tablet Diameter: 35 mm

The tablets covered those below indicated components in the indicated portions. The utilizable material is present in each case as powder. HF 200 is an oats fiber available as bright fine fiber bulk material, which is extracted from oats furs and exhibits an average fiber length of 250 micrometers (μm) and an average fiber thickness of 25 μm.

Decay determined in tap water of 50° C. in 400 ml

TABLE 3

| Utilizable | Dispersing | | | |
|---|---|---|---|---|
| material | agent | Pressing force | Stability | Decay (s) |
| 26 grams | 4 grams | 10 | very stable | none |
| “Herbalife” | HF 0414 | kiloNewtons | | |
| 26 grams | 4 grams | 10 | very stable | none |
| “Herbalife” | HF 0414, | kiloNewtons | | |
| | 3 grams | | | |
| | HF 200 | | | |
| 30 grams | 5 grams | 20 | i.O. | 40 seconds |
| Multaben whey | HF 0414 | kiloNewtons | | |
| cure | | | | |
| 20 grams whey | 3 grams | 15 | unstable | /. |
| drink | HF 0414 | kiloNewtons | | |
| 21.5 grams | 3.5 grams | 20 | unstable | /. |
| Multaben figure | HF 0414 | kiloNewtons | | |
| system pineapple | | | | |
| drink | | | | |

With the preceding experiments attempts a dispersing agent was only added to the diet drink powder. AS a comparison some attempts were accomplished in which another swelling means other than the dispersing agent was added to the diet drink powder.

Test conditions:

Tablet Diameter: 35 mm

Tablet: 85% utilizable material (Multaben whey cure with pineapple taste, consisting of sweet whey powder, citric acid, flavor material, sodium cyclamate, triglyceride and betacarotin+15% additive consisting of 90% oats fiber HF 600 and 10% Vivasol as swelling means, combined, compacted and granulated on a particle size between 0.4 and 1.4 mm (designated as HF 0414 V)

Decay determined in 400 milliliters water at 20° C.

TABLE 4

| Utilizable | Dispersing | Swelling | Pressing | | |
|---|---|---|---|---|---|
| material | agent | means | force | Stability | Decay |
| Multaben | Oats fiber | Vivasol | 20 | I. 0. | 31 seconds |
| whey cure | | | kiloNewton | | |

3. Tablet experiment soup powder

Test conditions:

Tablet Diameter: 35 mm

Tablet weight: 10 grams soup as powders+dispersing agents in form of oats fibers (HF 0414 V)

300 milliliters tap water at 100° C. and/or 65° C. and/or 20° C.

TABLE 5

| Utilizable material/ | | | |
|---|---|---|---|
| dispersing agent | Pressing power | Stability | Decay time |
| 10 grams soup | 50 kiloNewtons | i.O. | 70 seconds |
| 10 grams soup + 2.5 grams | 50 kiloNewtons | unstable, | 60 seconds |
| HF 0414 V (20%) | | crumbles | |
| | | easily | |

Water temperature 100° C.

TABLE 6

| Utilizable material/ | | | |
|---|---|---|---|
| dispersing agent | Pressing power | Stability | Decay time |
| 12 grams soup | 50 kiloNewtons | i.O. | >300 seconds |
| | | | with residues |
| 10 grams soup + 2.5 | 50 kiloNewtons | unstably, | 33 seconds |
| grams HF 0414 V (20%) | | crumbles | |
| | | easily | |
| 10 grams soup + 1 gram | 50 kiloNewtons | i.O. | 37 seconds |
| HF 0414V (9.1%) | | | |
| 10 grams soup + 0.5 | 50 kiloNewtons | i.O. | 41 seconds |
| grams HF 0414 V (4.7%) | | | |
| 10 grams soup + 0.37 | 50 kiloNewtons | i.O. | 100 seconds |
| grams HF 0414 V (3.5%) | | | |
| 10 grams soup + 0.25 | 50 kiloNewtons | i.O. | 85 seconds |
| grams HF 0414 V (2.4% | | | |
| 10 grams soup + 0.55 | 70 kiloNewtons | i.0., | 55 seconds |
| grams HF 0414 V (5.2%) | border | very well | |

Water temperature 65° C.

TABLE 7

| Utilizable material/ | | | |
|---|---|---|---|
| dispersing agent | Pressing power | Stability | Decay time |
| 10 grams soup + 0.55 | 60 kiloNewtons | i.O., very | >300 seconds |
| grams HF 0414 V (5.2%) | | well | with residues |

Water temperature 20° C.

With water at 100° C. no substantial shortening of the decay time is to be obtained by the addition of 20% HF 0414 V.

A clear improvement is visible with a water temperature of 65° C. A tablet without dispersing agents is not completely dispersed after five minutes. Even with a reduction of the oats fiber on 2.4% still another passable result is to be obtained.

The higher the fiber portion in the tablet is, the more unstable it becomes. The upper limit of the pressing power is 70 kiloNewtons for one to receive a sturdy tablet. If a higher pressure is selected, oil escapes from the soup tablet.

With a water temperature of 20° C. no complete dispersion is possible after even five minutes.

Because many varying and different embodiments may be made within the scope of the concepts taught herein, including modifications to the taught embodiments, the foregoing is to be interpreted as illustrative of the invention and not a limitation thereon.

What is claimed is:

1. A pressed composition capable of rapid dissolution in liquid with release of its content materials, said composition comprising a mixture of a finely-reduced utilizable material, said utilizable material being human and/or animal consumable, and a dispersion-promoting additive agent comprising a fine particle cellulose-containing material compacted under mechanical pressure.

2. The composition of claim 1 wherein said mixture is an essentially homogeneous mixture.

3. The pressed composition of claim 2 wherein said finely-reduced utilizable material has an average particle size of about 1 to about 8000 micrometers.

4. The pressed composition of claim 3 wherein said finely-reduced utilizable material has a particle size of about 15 to about 3000 micrometers.

5. The pressed composition of claim 2 wherein said dispersion-promoting agent has a particle size of about 100 to about 6000 micrometers.

6. The pressed composition of claim 2 wherein said dispersion-promoting agent is in a part by weight from about 2 to about 80 weight percent.

7. The pressed composition of claim 2 further comprising a finely-reduced swelling means.

8. The pressed composition of claim 7 wherein said finely-reduced swelling means is distributed essentially homogeneous in the mass of the pressed composition.

9. The pressed composition of claim 2 wherein said dispersion-promoting agent comprises a grain fiber.

10. The pressed composition of claim 9 wherein said grain fibers are treated according to the CTMP procedure.

11. The pressed composition of claim 7 wherein said finely-reduced swelling means is compacted under mechanical pressure and is present in said pressed composition as granulates.

12. The pressed composition of claim 11 wherein said finely-reduced swelling means is compacted and granulated and mixed essentially homogeneous and injected then with the finely-reduced utilizable material and the compacted and granulated dispersion-promoting agent.

13. The pressed composition of claim 12 wherein said finely-reduced swelling means is mixed essentially homogeneous with the finely-reduced dispersion-promoting agent and compacted and granulated then and then mixed with said finely-reduced utilizable material and pressed.

14. The composition of claim 2 wherein said additive agent comprises granulates.

15. The pressed composition of claim 1 further comprising a finely-reduced swelling means.

16. A pressed composition capable of rapid dissolution in liquid with release of its content materials, said composition comprising a mixture of a finely-reduced utilizable material, said utilizable material being human and/or animal consumable, and a dispersion-promoting additive agent comprising a fine particle cellulose-containing material compacted under mechanical pressure, said utilizable material and said additive being effectively in proportion with each other and, optionally, a swelling agent to effectively dissolve said composition in less than two minutes when introduced into liquid.
